(19) United States
(12) Patent Application Publication
(10) Pub. No.: US 2018/0192148 A1
(43) Pub. Date: Jul. 5, 2018

(54) METHOD, APPARATUS AND SYSTEM FOR THE RENDERING OF CONTENT

(71) Applicant: TECHNICOLOR USA, INC., Indianapolis, IN (US)

(72) Inventors: Joel M. FOGELSON, Pasadena, CA (US); Arden A. ASH, Los Angeles, CA (US); Krystie SWAVING, Los Angeles, CA (US); Guillaume Andre Roger GOUSSARD, Los Angeles, CA (US)

(21) Appl. No.: 15/580,681

(22) PCT Filed: May 18, 2016
(86) PCT No.: PCT/US2016/033060

§ 371 Date: Dec. 7, 2017

Related U.S. Application Data
(60) Provisional application No. 62/173,012, filed on Jun. 9, 2015.

(51) Int. Cl. H04N 21/488; H04N 5/63; G06F 1/32; G09G 5/00; G09G 3/34; H04N 21/41

(52) U.S. Cl. CPC H04N 21/488; H04N 5/63; H04N 21/41; G09G 5/003; G09G 3/34; G06F 1/3218

(57) ABSTRACT

A method, apparatus and system for generating content representations is provided. Respective power consumption information for content is determined. Representations for the content at relative luminance levels based on the respective power consumption information are rendered for display. Additionally, recommendations for reducing power consumption of content to be presented on a playback device can be directed to a user.

### TECHNICAL FIELD OF THE INVENTION

The present principles generally relate to energy/power usage and, more specifically, to determining power consumption of a playback device during presentation of content and rendering a representation of content reflective of an amount of power consumed during a presentation of the content.

### BACKGROUND OF THE INVENTION

Different media assets such as movies and television shows consume a large amount of power (watts) when such programs are watched using a display device and outputted with an audio system. The power consumption for playback of media assets is even larger with the use of high dynamic range (HDR) display devices because of the dynamic backlighting required by HDR display devices. The same may be true with high resolution programming such as 4K or 8K based video media which require more pixels on the screen than a typical standard definition or high definition display device where the display of such pixels may require more power than used for standard or high definition.

Currently there does not exist a device and/or a method for efficiently and effectively rendering a representation of content reflective of an amount of power consumed during a presentation of the content.

### SUMMARY OF THE INVENTION

Embodiments of the present principles are directed at least in part to addressing the deficiencies of the prior art by providing a method, apparatus and system for the rendering of content representations.

In one embodiment of the present principles, a method for generating content representations includes determining respective power consumption information for content and rendering, for display, representations for the content at relative luminance levels based on the respective power consumption information.

In an alternate embodiment of the present principles, an apparatus for generating content representations includes a memory for storing at least one of program routines, software, data, and power consumption information and a processor for executing the program routines. The apparatus is configured to determine respective power consumption information for content and render, for display, representations for the content at relative luminance levels based on the respective power consumption information.

In an alternate embodiment of the present principles, a system for generating content representations includes at least one communication interface for receiving at least one of video, audio and user inputs, a video processor processing received video, an audio processor processing received audio, a user input processor processing user input data and an apparatus comprising a memory for storing at least one of program routines, software, data, and power consumption information and a processor for executing the program routines. The apparatus is configured to determine respective power consumption information for content and render, for display, representations for the content at relative luminance levels based on the respective power consumption information.

### BRIEF DESCRIPTION OF THE DRAWINGS

These and other aspects, features and advantages of the present principles will be described or become apparent from the following detailed description of the preferred embodiments, which is to be read in connection with the accompanying drawings in which:

FIG. 1 depicts a display of an exemplary Electronic Program Guide (EPG) including information on power consumption of select content in accordance with an embodiment of the present principles;

FIG. 2 depicts a high level block diagram of an apparatus for determining power consumption of a playback device during the presentation of content and rendering respective representations of the content which reflect an amount of power consumed during a presentation of the content in accordance with an embodiment of the present principles; and

FIG. 3 depicts a high level block diagram of a power consumption module capable of being used in the apparatus of FIG. 2 in accordance with an embodiment of the present principles;

FIG. 4 depicts a high level block diagram of a system for monitoring power consumption and displaying representations of content in accordance with an embodiment of the present principle; and

FIG. 5 depicts a flow diagram of a method for determining power consumption for and displaying representations of content in accordance with an embodiment of the present principles.

It should be understood that the drawing(s) is for purposes of illustrating the concepts of the disclosure and is not necessarily the only possible configuration for illustrating the disclosure. To facilitate understanding, identical reference numerals have been used, where possible, to designate identical elements that are common to the figures.

### DETAILED DESCRIPTION OF THE INVENTION

Embodiments of the present principles advantageously provide a method, apparatus and system for determining power consumption of a playback device during the presentation of content and rendering respective representations of the content which reflect an amount of power consumed during a presentation of the content. Although the present principles will be described primarily within respect to the presentation of content on a display and for rendering representations of the content for display in an electronic program guide (EPG), the specific embodiments of the present principles should not be treated as limiting the scope of the invention. It will be appreciated by those skilled in the art and informed by the teachings of the present principles that the concepts of the present principles can be applied to the playback of audio, video and/or audio/video content on substantially any playback device for determining energy usage of the playback device during the presentation of the content and rendering respective representations of the content which reflect an amount of power consumed during a presentation of the content for display in substantially any format, including an EPG.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

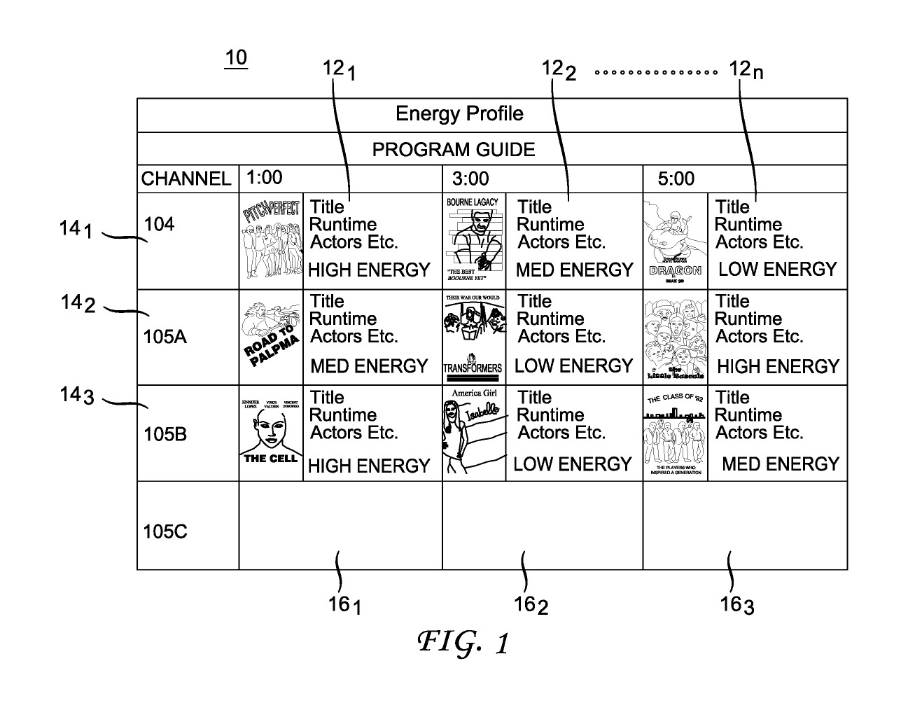

FIG. 1 depicts a display of an exemplary Electronic Program Guide (EPG) including information on energy usage/consumption of select content in accordance with an embodiment of the present principles. The EPG 10 of FIG. 1 includes a rectangular array of elements arranged in rows and columns. For ease of description, the array depicted in FIG. 1 comprises 3 rows by 3 columns, although the size could be smaller or larger depending on design preferences. The rows 14₁-14₃ of the array comprising the EPG 10 correspond to different content sources or channels. The columns 16₁-16₃ correspond to different time intervals, exemplified by 1:00 PM, 3:00 PM and 5:00 PM, respectively. Note that the arrangement of rows and columns in FIG. 1 are exemplary and can be reversed. In other words, the rows and columns of the EPG 10 of FIG. 1 can correspond to time intervals and channels, respectively. Cells 12₁-12ₙ, of the EPG grid array 10 each correspond to a program broadcast on a particular channel that appears during a particular time interval. The size of each cell 12₁-12ₙ, varies with the program duration. Thus, a cell representing a content program one hour in duration will have twice the size compared to a cell representing a program having a duration of a half-hour. Given that the EPG 10 undergoes updating to reflect the passage of time, the actual size of each cell 12₁-12ₙ appearing in the EPG grid array 10 will change depending on the time remaining in the program. Thus, a cell which represented a program one-hour in duration will shrink to one-half its size after a half-hour has elapsed since the start of the program. Within each cell 12₁-12ₙ is displayed data representing a program on a particular channel and broadcast by a particular station at the time indicated by the row and column headings.

In accordance with embodiments of the present principles, provided in each cell are indicia indicating an amount of measured or expected power that each listed program will or is expected to consume when presented on a playback/presentation device such as a display device. In the embodiment of FIG. 1, each cell in the EPG is shown as displayed at a different level of brightness corresponding to the amount of measured or expected power consumption associated with the presentation of content on a specific display. Based on information either received by an apparatus/system of the present principles (described below) or determined by an apparatus/system of the present principles (described below), the different cells identifying particular programs are shown at different luminance levels depending on an amount of measured or expected power consumption associated with the presentation of content on a specific display. That is, based on how much power is expected to be used during the presentation of the program on a display, the listing of the program (in the cell) is shown at a proportional level of brightness. For example, if it is expected that a program will use up 25 Watts (W) during presentation on a display, the cell for the program is shown at a relatively lower level of brightness; if it is expected that a program will use between 25 W to 50 W, the cell for the program in the EPG is shown at a middle level of brightness; and if a program is expected to use more than 50 W during a presentation, the corresponding cell is shown at a relatively higher level of brightness. The levels of brightness can include more than the three levels explained above in alternative embodiments thereby providing a more accurate reflection of the luminance level of the respective program.

For purposes of the following description, measured or expected power consumption is identified by indicia indicating low, medium or high, as relative terms. Low represents a low amount of power consumption, medium represents a medium amount of power consumption, and high represents a high amount of power consumption, respectively, for a display device. The ranges of values representing these levels can be determined by a content provider, broadcaster, user, or the device itself. For example, there can be a service at a head end that rates the power consumption of a program in reference to a standard 5,000 nits or 10,000 nits display. In various embodiments of the present principles, this rating can be transmitted as metadata as part of the media asset with a broadcast of the media asset. For example a metadata field called “Power” can be defined as the expected power consumption used for a particular display, program, and the like.

It should be noted that in various embodiments of the present principles, the power consumption analysis described above can include audio properties of content as well video properties of content. For example, a 5.1 version of a content program using a 100 Watt Rated Receiver can use X watts during presentation while a stereo version of a program using a 100 Watt Rated Receiver can use Y watts. These numbers could be scaled up or down based on criteria provided by a manufacturer, actual usage of a device, and the like. The indicia depicted in the figure to identify measured or expected power consumption is for purposes of example only. In practice, any indicia or combination of indicia including but not limited to numerical values, icons, colored cells, brightness levels, etc. can be used to indicate particular levels of measured or expected power consumption in accordance with various embodiments of the present principles. Additionally, the described exemplary embodiment discusses the power consumption of a program provided on a channel and provided by a particular program source. However, the present principles can apply to any audio, video and/or audio/video content being reproduced thereby including recordings, Video on Demand (VOD), internet videos, etc. Note, alternative representations of program listings can be implemented in accordance with embodiments of the present principles. In addition, for purposes of the following description of the present principles, the terms energy and power and energy usage, power usage and power consumption can be used interchangeably throughout the teachings of the present principles.

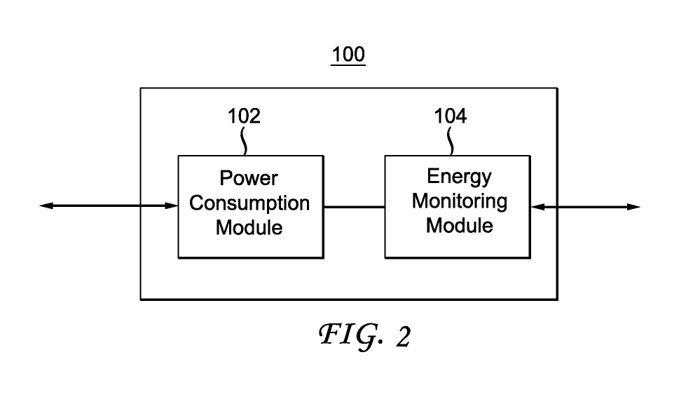

FIG. 2 depicts a high level block diagram of an apparatus 100 for determining power consumption of a playback device during the presentation of content and rendering respective representations of the content which reflect an amount of power consumed during a presentation of the content in accordance with an embodiment of the present principles. Illustratively, the apparatus 100 of FIG. 2 includes a power consumption module 102 and an energy monitoring module 104. In various embodiments of the present principles, the energy monitoring module 104 can include a smart power supply and/or an energy monitor, and/or any other such device capable of monitoring power consumption of, for example, a display device during the presentation of specific content.

In one embodiment of the present principles, the apparatus 100 of FIG. 2 is capable of receiving at least information related to program content and, alternatively the program content itself. That is, data for content including at least power consumption information, which can be used to render respective representations of the content which reflect an amount of power consumed during a presentation of the content for use in, for example, the EPG as shown in FIG. 1, can be obtained from any of but not limited to electronic program guide information transmitted as part of broadcast programming (such as PSIP information, etc.) received from a database containing EPG information, auxiliary information embedded in a media file (broadcasted or streamed), a separate stream of auxiliary information separated from broadcasted/streamed media, and the like.

In an alternate embodiment of the present principles, the apparatus 100 can determine/monitor power consumption information which can be used to render respective representations of the content which reflect an amount of power consumed during a presentation of the content for use in, for example, the EPG as shown in FIG. 1. That is, in such an embodiment, the apparatus of FIG. 2 can provide power for a playback device to be used to present content of interest and, as such, the energy monitoring module 104 can monitor a power consumption of the playback device being used to present specific content. Such information is communicated from the energy monitoring module 104 to the power consumption module 102 to determine the power consumption information for the purposes of rendering respective representations of the content which reflect an amount of power consumed during a presentation of the content for use in, for example, the EPG as shown in FIG. 1.

In an alternate embodiment of the present principles, the apparatus 100 of FIG. 2 does not provide power for the playback device, however power consumption information for the playback device is communicated from, for example, a power supply of the playback being used to present content of interest to the apparatus 100. In such an embodiment of the present principles, the apparatus 100 of FIG. 2 only needs to include an power consumption module 102 of the present principles and if an energy monitoring module does exist, its only function would be to communicate the power consumption information communicated to the apparatus to the power consumption module 102 of the apparatus 100 of FIG. 2. The power consumption module 102 then uses the power consumption information to render respective representations of the content which reflect an amount of power consumed during a presentation of the content for use in, for example, the EPG as shown in FIG. 1. That is and as described above, the power consumption module 102 uses determined power consumption information to render for display representations of various content programs at different luminance levels in accordance with the determined power consumption levels.

In various embodiments of the present principles, representations of content are generated by an apparatus of the present principles using, for example, a frame or frames of received content. The luminance levels of the content representations are then adjusted for display based on respective power consumption information determined. In alternate embodiments, the power consumption module 102 of the present principles adjusts luminance levels of already existing representations of the content based on the determined power consumption information as described above. Such representations can be stored in a memory accessible to the power consumption module 102.

In alternate embodiments of the present principles, the power consumption module 102 of an apparatus of the present principles is configured to determine power consumption of devices by querying another device, such as a smart home apparatus or display. For example in one embodiment, a playback device with which the apparatus 100 is in communication can be plugged into a “smart” outlet or energy monitor that keeps track of power consumption. The power consumption module 102 can be configured to query the “smart” outlet for power consumption information related to particular content of interest. An apparatus of the described embodiment can be used in a “smart home” using smart appliances and monitoring techniques. The described apparatus of the present principles can also query the playback device itself for such information in embodiments in which the playback device determines its own power consumption.

In various embodiments of the present principles as described above, a set of commands can be used to enable an apparatus of the present principles to query another device for the information regarding power consumed for at least a particular time period during the display of a program content of interest. For example, a sample command “Power Consumed from 12:00-13:00-03/14/2014” can be a command sent by the power consumption module 102 to a connected device to inquire as to the amount of power consumed during the desired period of time. In one embodiment, the format of the command can include:
HH:MM-HH:MM/Date/Month/Year
   The queried device can exemplary return a value such as “100 W” which represents 100 Watts.
#W=# of Watts.

In an alternate embodiment of the present principles, the power consumption module 102 can make an estimation of the power consumption of content. For example, the power consumption module 102 can estimate the expected power consumption of a program in a series including numerous episodes by analyzing an power consumption of other episodes within the same series. The power consumption module 102 then uses such information for rendering respective representations of the content which reflect an amount of power consumed during a presentation of the content for use in, for example, the EPG as shown in FIG. 1.

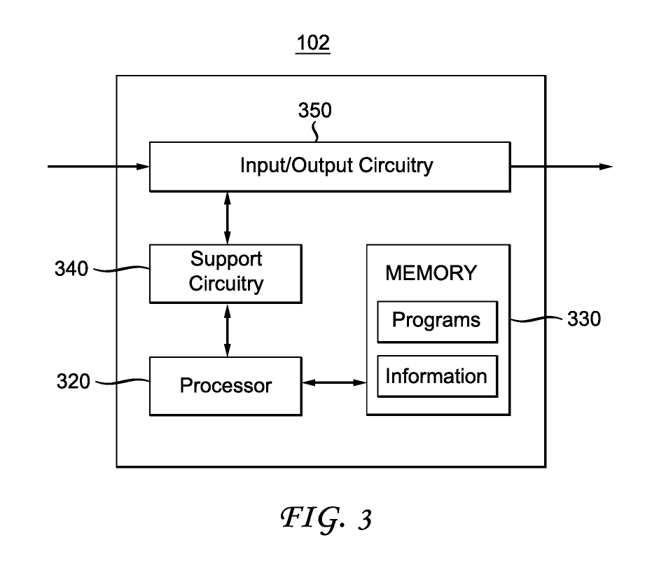

FIG. 3 depicts a high level block diagram of a power consumption module 102 capable of being used in the apparatus 100 of FIG. 2 in accordance with an embodiment of the present principles. The power consumption module 102 of FIG. 3 illustratively comprises a processor 320 as well as a memory 330 for storing control programs, instructions, software, data, power consumption information and the like. The processor 320 cooperates with conventional support circuitry 340 such as power supplies, clock circuits, cache memory and the like as well as circuits that assist in executing the software routines stored in the memory 330. As such, it is contemplated that some of the process steps discussed herein as software processes can be implemented within hardware, for example, as circuitry that cooperates with the processor 320 to perform various steps. The power consumption module 102 of FIG. 3 also contains input-output circuitry 350 that forms an interface between the various respective functional elements communicating with the power consumption module 102. As noted throughout this disclosure, the memory 330 can be a hard disk storage device, a static RAM, a DRAM, ROM, etc., or combinations of the same.

Although the power consumption module 102 of FIG. 3 is depicted as a general purpose computer that is programmed to perform various control functions in accordance with the present principles, the invention can be implemented in hardware, for example, as an application specified integrated circuit (ASIC). As such, the process steps described herein are intended to be broadly interpreted as being equivalently performed by software, hardware, or a combination thereof.

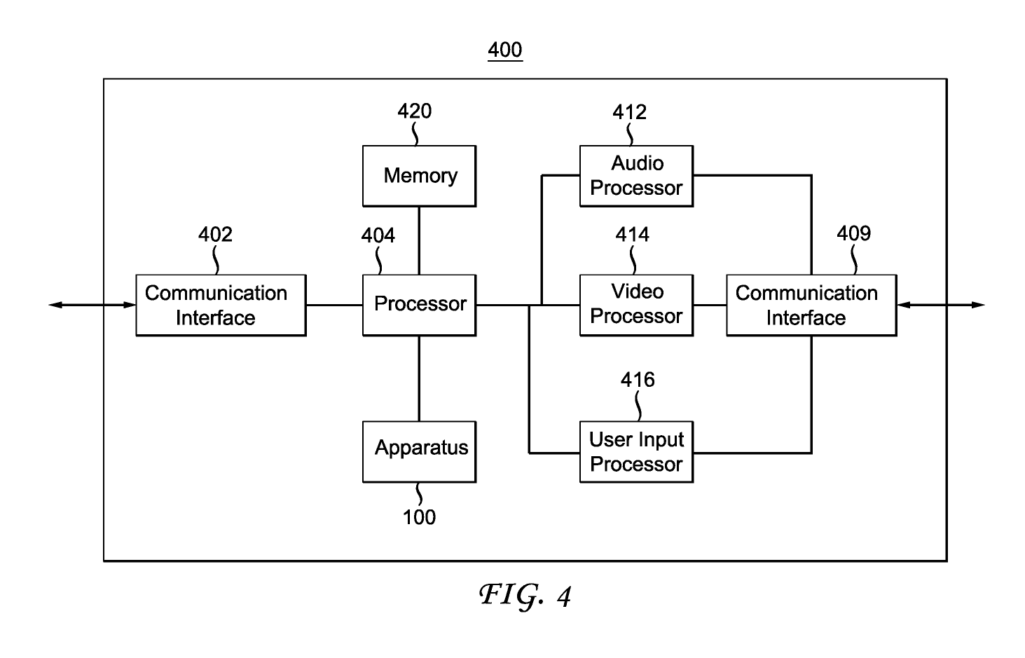

FIG. 4 depicts a high level block diagram of a system 400 for monitoring energy usage and displaying representations of content in accordance with an embodiment of the present principle. That is, in various embodiments of the present principles, the apparatus 100 of FIG. 2 can be included in a display device, a set top box, a tuner, a playback device and the like, for determining energy usage and rendering representations of content in accordance with the present principles. The system 400 of FIG. 4 illustratively comprises an apparatus 100 of the present principles, a first communication interface 402, a processor 404, a second communication interface 408, a memory 410, an audio processor 412, a video processor 414 and a user input processor 416. In the system 400 of FIG. 4, the memory 410 stores data such as but not limited to channel information, EPG data, applications used by the processor 404, information such as power consumption related to various programs, etc. The first communication interface 402 receives programming content and information related to such content. The audio processor 412 processes audio content for reproduction of an audio signal. The video processor 414 processes video content for display by a connected display device. The user input processor 416 processes user input data such as channel change commands or other selection and operational control data. Each of these devices is connected to the communication interface 408 for connection to a display device or other device for reproduction of the EPG and content.

It should be understood that the elements set forth in FIG. 4 are illustrative. The system 400 can include any number of the elements depicted and certain elements can provide part or all of the functionality of other elements. Other possible implementations will be apparent to one skilled in the art given the benefit of the present principles.

In the embodiment of FIG. 4 and other such embodiments, the apparatus 100 of the present principles is used for determining energy usage of particular program content and for rendering respective representations of the content which reflect an amount of power consumed during a presentation of the content for use in, for example, the EPG as shown in FIG. 1, in accordance with the present principles.

In any of the embodiments described above, an apparatus/system of the present principles is capable of rendering at least one of a user interface, EPG, program listing, and the like for providing power consumption information to a user. As describe above, in determining the power consumption, embodiments exist in which power consumption information will be provided and alternate embodiments in which an amount of power to be consumed during the playback of particular content is not known. That is, in various embodiments, an apparatus/system of the present principles will have to determine how much power will be consumed during the playback of a program on a specific display. As such, in one embodiment, an apparatus/system of the present principles determines whether or not information related to the power consumption of a program to be presented on a playback device is available.

If the apparatus/system determines that the power consumption information is available (e.g., has been received), the apparatus/system using for example a power consumption module 102 of FIG. 2 generates, for display in for example an EPG, representations for the content at relative luminance levels based on the determined power consumption information. If the apparatus/system determines that the power consumption information is not available (not received), the apparatus/system monitors/measures power consumption of the playback device during presentation of specific content using for example the energy monitoring module 104 of FIG. 2.

It should be noted that the term content and program content used throughout the teachings of the present principles can be interpreted to include audio, video and/or audio video content. That is, in an various embodiments of the present principles a determination can be made, using for example the power consumption module 102 of FIG. 2, whether an audio system is being used during playback of the program. For example, the use of HDMI connections between a viewing apparatus (display) and a receiver, such as a set top box or tuner, can indicate that an additional audio system is being used. If so, power consumption for the audio system can be determined in a similar way as described above with respect to power consumption associated with the presentation of content on a display. That is, power consumption information associated with the playing of audio on a playback device, such as a display, can either be received by an apparatus/system of the present principles or can be monitored by an apparatus/system of the present principles as described above with reference to power consumption information determined for other content.

As such, it should be noted that a representation generated for content at relative luminance levels based on respective power consumption information can represent power consumption of content which includes, audio, video and/or audio and video in accordance with various embodiments of the present principles.

In further embodiments of the present principles, an apparatus/system of the present principles as described above can provide suggestions for reducing an amount of power expected to be consumed during presentation of content. For example, in one embodiment of the present principles when an apparatus of the present principles determines an amount of power that is expected to be consumed by particular content, the apparatus/system can suggest reducing power consumption by suggesting that content be watched without a backlight if the power to be consumed during the presentation of the content exceeds a threshold that in various embodiments can be determined or preset by a user or limited by a device. That is, a device can limit an amount of power that can be consumed when presenting content on the device at least because of the power limitations (i.e., battery life) of the device.

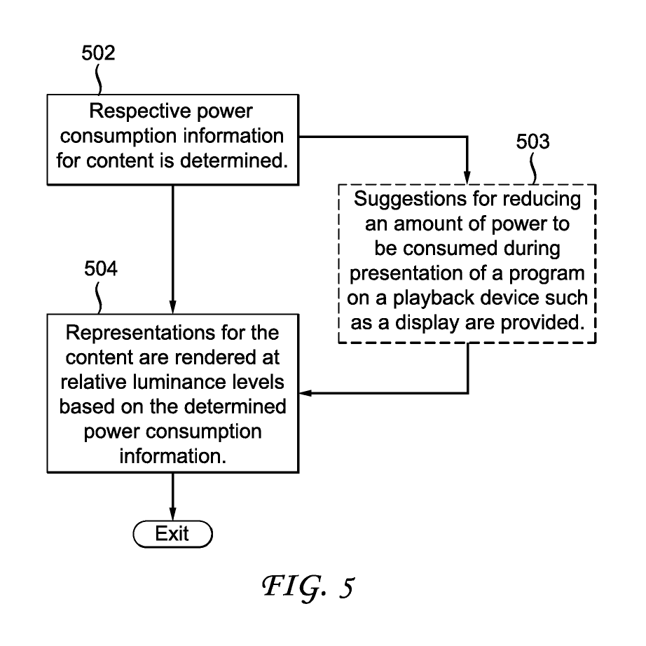

FIG. 5 depicts a flow diagram 500 of a method for determining power consumption for and displaying representations of content in accordance with an embodiment of the present principles. The method 500 begins at step 502 during which respective power consumption information for content is determined. For example, as described above, in one embodiment such power consumption information for content is determined from information received from a content source or creator and/or a power measuring device regarding how much power is consumed by the presentation of particular content on a specific presentation device such as a display. Additionally and as described above, such power consumption information can be determined by querying a smart home apparatus and/or display that determines its own power consumption. In an alternate embodiment of the present principles and as described above, power consumption information for content is determined by measuring power consumption of content being presented on a playback device using, for example, an energy measuring device such as a smart power supply and/or an energy monitor and the like which measures an amount of power consumed during the presentation of particular content on a playback device. The method 500 can then proceed to optional step 503 or can skip to step 504.

At optional step 503, suggestions for reducing an amount of power to be consumed during presentation of a program on a playback device such as a display are provided. For example and as described above, in one embodiment, an apparatus of the present principles can provide suggestions for reducing power consumption such as by watching the program without a backlight if the energy to be consumed during the presentation of the content exceeds a threshold that in various embodiments can be determined or preset by a user or limited by a playback device. Such suggestion can be presented to a user via a display or other user interface. The method 500 can then proceed to step 504.

At step 504, representations for the content are rendered at relative luminance levels based on the determined power consumption information. That is, as described above, in one embodiment of the present principles an EPG, such as the EPG of FIG. 1, is populated such that content representations in each cell in the EPG are shown as displayed at a different level of brightness corresponding to the determined power consumption associated with the presentation of a respective content on a specific playback device, such as a display. Based on information either received by an apparatus/system of the present principles or determined by an apparatus/system of the present principles, the different cells identifying particular programs are shown at different luminance levels depending on determined power consumption associated with the presentation of the content on a specific playback device. That is, based on how much power is used during the presentation of the content on, for example, a display, the representation of the program (in the cell) is shown at a proportional level of brightness. As described above, in one embodiment of the present principles content representations having luminance levels relative to determined power consumption levels for content being presented on a playback device are generated by an power consumption module of the present principles. Such content representations can then be populated into a related EPG. In alternate embodiments of the present principles, the display of existing content representations are manipulated to be displayed at relative luminance levels based on determined respective power consumption for content being presented on a display. The method 500 can then be exited.

Although embodiments which incorporate the teachings of the present disclosure have been shown and described in detail herein, those skilled in the art can readily devise many other varied embodiments that still incorporate these teachings. Having described preferred embodiments of a method, apparatus and system for determining energy usage of a playback device during the presentation of content and rendering respective representations of the content which reflect an amount of energy consumed during a presentation of the content (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method for generating content representations comprising:
determining respective power consumption information for a plurality of content; and
rendering, for display, representations for the contents at relative luminance levels based on said respective power consumption information.

2. The method of claim 1, wherein wherein the apparatus generates a representation at a luminance level representative of power consumption required for display of the content, a higher the luminance level of a respective content representation indicates a higher power consumption and a lower the luminance level of a respective content representation indicates a lower power consumption.

3. (canceled)

4. The method of claim 1, wherein content representations are displayed with luminance levels respective of a power consumption required for presenting the respective content.

5. The method of claim 4, wherein said content representations are displayed on an electronic program guide.

6. The method of claim 1, comprising setting a maximum limit for power consumption of content to be displayed.

7. The method of claim 6, comprising prompting a user to alter a display setting for content exceeding the maximum power consumption limit.

8. (canceled)

9. The method of claim 1, wherein said power consumption information is determined by monitoring a presentation of content and measuring power consumption information.

10. (canceled)

11. The method of claim 1, wherein said power consumption information is determined by querying a smart home apparatus with which a device displaying the content is in communication.

12. The method of claim 5, wherein the electronic program guide indicates if the power consumption includes use of an audio system.

13. An apparatus for displaying content representations comprising:
a memory for storing at least one of program routines, software, data, and power consumption information;
a processor for executing said program routines;
said apparatus configured to:
determine respective power consumption information for a plurality of content; and
render, for display, representations for the contents at relative luminance levels based on said respective power consumption information.

14. The apparatus of claim 13, wherein the apparatus generates a representation at a luminance level representative of power consumption required for display of the content, a higher the luminance level of a respective content representation indicates a higher power consumption and a lower the luminance level of a respective content representation indicates a lower power consumption.

15. The apparatus of claim 13, wherein said apparatus presents said content representations in an electronic program guide.

16. The apparatus of claim 13, wherein said memory stores a value indicative of a maximum limit for power consumption for presentation of the content.

17. The apparatus of claim 16, wherein said apparatus generates instructions directed to a user to alter a display setting when a power consumption of content is determined to exceed the maximum power consumption limit.

18. (canceled)

19. The apparatus of claim 13, comprising an energy monitoring module for measuring power consumption of content.

20.-22. (canceled)

23. An system for displaying content representations comprising:
a communication interface for receiving at least one of video, audio and user inputs;
a video processor processing received video;
an audio processor processing received audio;
a user input processor processing user input data; and
an apparatus comprising a memory for storing at least one of program routines, software, data, and power consumption information and a processor for executing said program routines;
said apparatus configured to:
determine respective power consumption information for a plurality of content; and
render, for display, representations for the contents at relative luminance levels based on said respective power consumption information.

24. The system of claim 23, wherein said system comprises at least one of a set top box and a tuner.

25. The system of claim 23, wherein the system generates a representation at a luminance level representative of power consumption required for display of the content, a higher the luminance level of a respective content representation indicates a higher power consumption and a lower the luminance level of a respective content representation indicates a lower power consumption.

26.-28. (canceled)

29. The system of claim 23, wherein said system determines said power consumption information from information received from a content source.

30. The system of claim 23, wherein said system determines said power consumption information by querying a smart home apparatus with which the apparatus is in communication.
